(19) United States
(12) Patent Application Publication
(10) Pub. No.: US 2009/0277087 A1
(43) Pub. Date: Nov. 12, 2009

(54) THE VEGETATION BLOCK FRAME AND THE VEGETATION BLOCK

(76) Inventor: Heung Seob Kim, Gyeonggi-do (KR)

Correspondence Address: DICKSTEIN SHAPIRO LLP, 1825 EYE STREET NW, Washington, DC, 20006-5403, US

(21) Appl. No.: 12/306,128

(22) PCT Filed: Jul. 5, 2007
(86) PCT No.: PCT/KR2007/003261

§ 371 Date: Dec. 22, 2008

(30) Foreign Application Priority Data
Jul. 5, 2006 (KR) 10-2006-0063097

(51) Int. Cl. A01G 9/02; E02B 3/14

(52) U.S. Cl. 47/85; 47/87

(57) ABSTRACT

A vegetation block frame and a vegetation block. The vegetation block frame includes a bottom plate; outer walls 120, which define an inner space with the bottom plate; and a plurality of partitions extending crosswise and lengthwise inside the inner space, thereby forming a plurality of unit vegetation spaces. Each of the bottom plate and the partitions has a plurality of holes, and concavities and convexities are alternately formed in the upper and lower parts of the outer walls. A step block is selectively inserted into one of the unit vegetation spaces. The internal space is partitioned into the unit vegetation spaces by the partitions having the holes, so that herbs, plants and trees can easily take root and grow. The concavities and convexities are formed in the outer walls of the vegetation block frame engage with each other, thereby preventing twisting and upward separation after construction.

### TECHNICAL FIELD

The present invention relates to a vegetation block frame and a vegetation block.

### BACKGROUND ART

The present invention relates, in general, to a vegetation block frame and a vegetation block, and more particularly, to a vegetation block frame and a vegetation block, in which an internal space, defined by outer walls on the top of a bottom plate, is partitioned into a plurality of unit vegetation spaces by partitions having holes, thereby enabling herbs, plants or trees to easily take root and grow in the unit vegetation spaces, and in which concavities and convexities are formed in outer walls of the vegetation block frame in the lengthwise direction so as to engage with each other, thereby preventing the vegetation block from being twisted or coming loose after construction.

In general, such vegetation blocks have holes in the center thereof and flat front and rear surfaces, are stacked in a crossed state such that a predetermined space is formed in an up and down direction, and are then interconnected by injecting mortar. These vegetation blocks provide a bad appearance because the flat front and rear surfaces thereof make it impossible to hold earth and sand. Further, the vegetation blocks make propagation (settling, growth) of plants and the like impossible, thereby being disharmonious with the surrounding environment, and furthermore, acting as a source of ecocide.

Recently, as interest in environmental protection increases, the need for eco-friendly products increases. Thus, the interest in eco-friendly vegetation blocks, which simply prevent the earth and sand from settling, make the propagation of plants and the like possible, and have a good appearance, is increased.

However, these existing vegetation blocks cannot provide space for the plants to propagate because the front and rear surfaces thereof are flat surfaces. This fails to meet such needs. Further, in the case in which the vegetation blocks are used for the bank of a river or the like, no friction occurs between the front surface of the constructed vegetation blocks and the river water, and thus the rate of flow is increased. Thereby, the settlement of the ground is accelerated, and simultaneously the propagation of the plants is more difficult. The vegetation blocks are vertically stacked in a crossed state, so that, in the case in which one of the vegetation blocks is washed away, other neighboring vegetation blocks are sequentially washed away. The vegetation blocks are maintained and constructed in a manner such that the side of one vegetation block is in contact with that of another one, so that they are overall constructed in a twisted shape.

### DISCLOSURE OF INVENTION

### Technical Problem

Accordingly, the present invention has been made in an effort to solve the problems occurring in the related art, and an object of the present invention is to provide a vegetation block frame, in which an internal space defined by outer walls on top of a bottom plate is partitioned into a plurality of unit vegetation spaces by partitions having holes, so that herbs, plants or trees can easily take root and grow.

Another object of the present invention is to provide a vegetation block, in which convexities and concavities are formed in outer walls constituting a vegetation block frame in the lengthwise direction so as to be engaged with each other, thereby preventing twisting and upward separation after construction.

### Advantageous Effects

In this manner, the present invention can realize an effect in which herbs, plants or trees can easily take root and grow by partitioning the internal space, which is defined by the outer walls on top of the bottom plate, into the plurality of unit vegetation spaces using the partitions having holes. Further, it can further realize an effect in which the vegetation blocks can be prevented from becoming twisted and separated from the ground in an upward direction after construction by forming the convexities and concavities in the outer walls constituting the vegetation block frame in a lengthwise direction so as to be engaged with each other.

### BRIEF DESCRIPTION OF THE DRAWINGS

FIG. 1 is an exploded perspective view illustrating a vegetation block frame according to the present invention;

FIG. 2 is a cutaway perspective view illustrating the main part of a vegetation block frame according to the present invention;

FIG. 3 is a top plan view illustrating a vegetation block frame according to the present invention;

FIG. 4 is a sectional view illustrating a vegetation block according to the present invention;

FIG. 5 is a top plan view illustrating the state in which vegetation blocks according to the present invention are constructed;

FIG. 6 is a detailed longitudinal sectional view illustrating the state in which vegetation blocks according to the present invention are coupled to each other by bolts;

FIG. 7 is a longitudinal sectional view illustrating the state in which a spacer and a step block are inserted in a vegetation block according to the present invention;

FIG. 8 is a top plan view illustrating a vegetation block frame according to a second embodiment of the present invention;

FIG. 9 is a top plan view illustrating a vegetation block frame according to a third embodiment of the present invention;

FIG. 10 is a top plan view illustrating a vegetation block frame according to a fourth embodiment of the present invention;

FIG. 11 is a top plan view illustrating a vegetation block frame according to a fifth embodiment of the present invention;

FIG. 12 is a top plan view illustrating a vegetation block frame according to a sixth embodiment of the present invention;

FIG. 13 is a top plan view illustrating a vegetation block frame according to a seventh embodiment of the present invention;

FIG. 14 is a top plan view illustrating a vegetation block frame according to an eighth embodiment of the present invention;

FIG. 15 is a top plan view illustrating a vegetation block frame according to a ninth embodiment of the present invention;

FIG. 16 is a top plan view illustrating a vegetation block frame according to a tenth embodiment of the present invention;

FIG. 17 is a top plan view illustrating a vegetation block frame according to an eleventh embodiment of the present invention; and

FIG. 18 is a top plan view illustrating a vegetation block frame according to a twelfth embodiment of the present invention.

### MAJOR REFERENCE NUMERALS AND SIGNS OF THE DRAWINGS

a: hole b: concavity
c: convexity H: height
100: block frame 110: bottom plate
120: outer wall 130: partition
140: unit vegetation space
200: spacer 300: step block

### BEST MODE FOR CARRYING OUT THE INVENTION

According to an aspect of the invention for realizing the above object, there is provided a vegetation block frame 100 of a multifunctional vegetation block. The vegetation block frame 100 of the invention includes a bottom plate 110; outer walls 120, which, together with the bottom plate 110, define an inner space; and a plurality of partitions 130 extending crosswise and lengthwise inside the inner space, thereby forming a plurality of unit vegetation spaces 140. Each of the bottom plate and the partitions has a plurality of holes a, and concavities b and convexities c are alternately formed in the upper and lower parts of the outer walls 120, which are defined by the horizontal line at a vertical position corresponding to half the height H of the outer walls 120.

Here, the concavities b and the convexities c also alternate with each other in the longitudinal direction of the outer walls 120.

Preferably, the outer walls 120 of the block frame 100 have holes a formed therein, and a stepped sector-shaped bolt guide recess 125 is vertically formed in an upper portion of a corner of the outer walls 120. The bolt guide recess 125 contacts a bolt guide recess 125′, which is formed in a corner of outer walls of another vegetation block frame 100′, thereby forming one cylindrical shape. In addition, a spacer 200 in the shape of a cross is inserted into a corresponding one of the unit vegetation spaces 140. The vegetation block frame 100 can further include a hook nut 310 for being hooked to a net 300, when the net 300 is placed under the vegetation block frame 100, and a bolt 320 having a washer 321 fitted thereon. The bolt 320 is screwed into the hook nut 310, thereby tightly holding the hook nut 310 to the bottom.

According to another aspect of the invention for realizing the above object, there is provided a multifunctional vegetation block. The multifunctional vegetation block includes a step block 400 inserted into a vegetation block frame 100. The vegetation block frame 100 includes a bottom plate 110; outer walls 120, which define an inner space together with the bottom plate 110; and a plurality of partitions 130 extending crosswise and lengthwise inside the inner space, thereby forming a plurality of unit vegetation spaces 140. Each of the bottom plate and the partitions has a plurality of holes a.

Concavities b and convexities c are alternately formed in the upper and lower parts of the outer walls 120, which are defined by the middle line at the height H of the outer walls 120. The concavities b and the convexities c also alternate with each other in the longitudinal direction of the outer walls 120. The step block 400 is selectively inserted into a corresponding one of the unit vegetation spaces 140.

The vegetation block frame 100 further includes a spacer 200 in the form of a cross, which is inserted into the corresponding unit vegetation space. The step block 400 is selectively inserted into the corresponding unit vegetation space, on top of the cross spacer 200.

Hereinafter, the invention will be described more fully in conjunction with the accompanying drawings, in which exemplary embodiments thereof are shown.

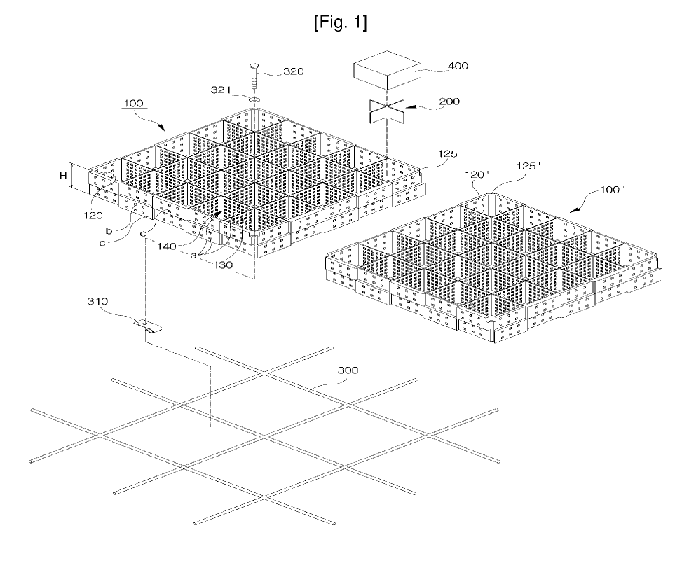

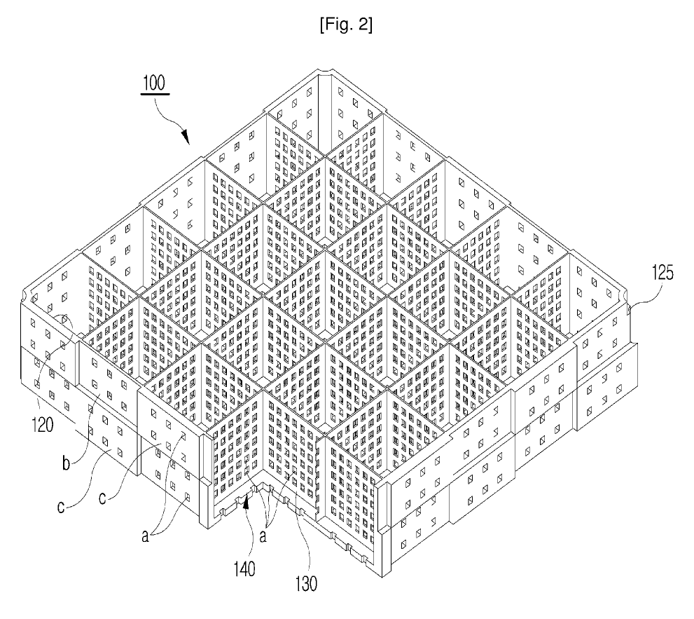

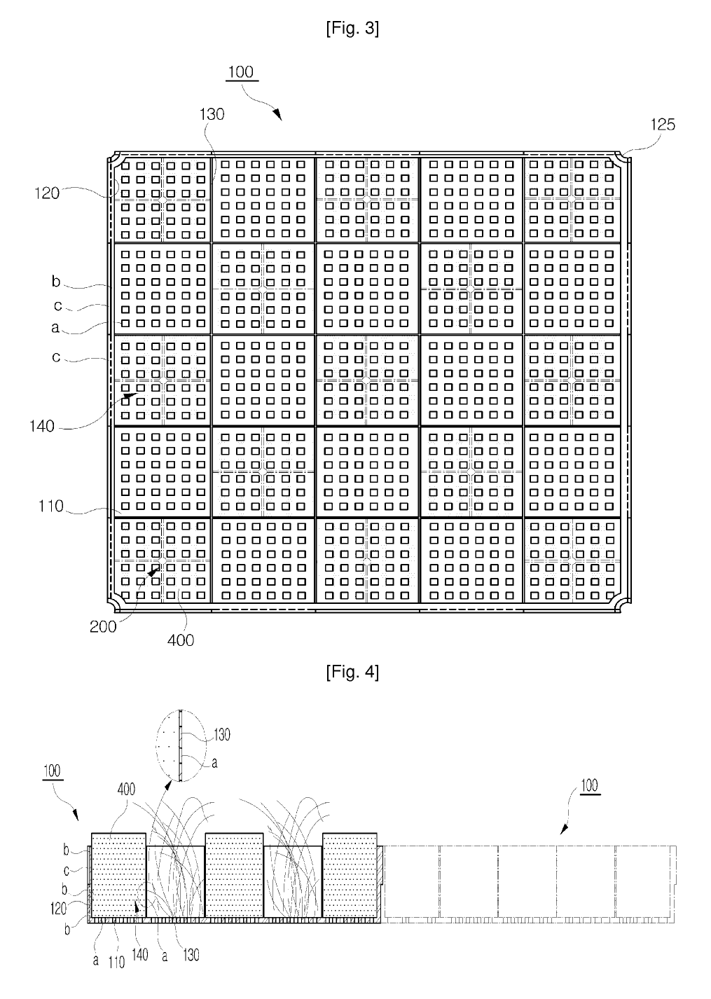

As shown in FIGS. 1 to 7, in the block frame 100 of the invention, the bottom end of the vertical outer walls 120 is integrally formed with the circumference of the bottom plate 110, which has a predetermined thickness and area, so that the internal space is defined by the upper surface of the bottom plate 110 and the inside surface of the outer walls 120. The partitions 130 extend crosswise and lengthwise inside the inner space, thereby forming the unit vegetation spaces 140.

The holes a, formed in the bottom plate 110 and the partitions 130, which define the unit vegetation spaces 140, can help herbs, plants or trees easily take root and grow.

The concavities b and the convexities c are alternately formed in the upper and lower parts of the outer walls 120, which are defined by the middle line at the height H of the outer walls 120. When the vegetation block frame 100 is coupled with another vegetation block frame 100′, the concavities b and the convexities c prevent any of the frames from being removed from each other.

The holes a are also formed in the outer walls 120, in which the concavities b and the convexities c are alternately formed.

During the process of growth, in which the plants and the trees take root inside the unit vegetation spaces 140, roots can laterally extend through the holes. This can further enhance the coupling force between the block frames 100 and 100′. Preferably, the vegetation block frame 100 is produced by injection-molding synthetic resin.

The bolt guide recess 125 is vertically formed in the upper portion of the corner, where the outer walls 120 meet each other. The bolt guide recess 125 has a stepped sector shape, and has a length corresponding to ¼ of the circumference. The bolt guide recess 125 contacts the bolt guide recess 125′, which is formed in the corner of the outer walls of the vegetation block frame 100′, thereby forming one cylindrical shape.

The step block 400 is made, for example, of yellow earth, rock, wood and/or cement, and is inserted into the unit vegetation space 140 of the block frame 100, configured as above, thereby realizing one vegetation block.

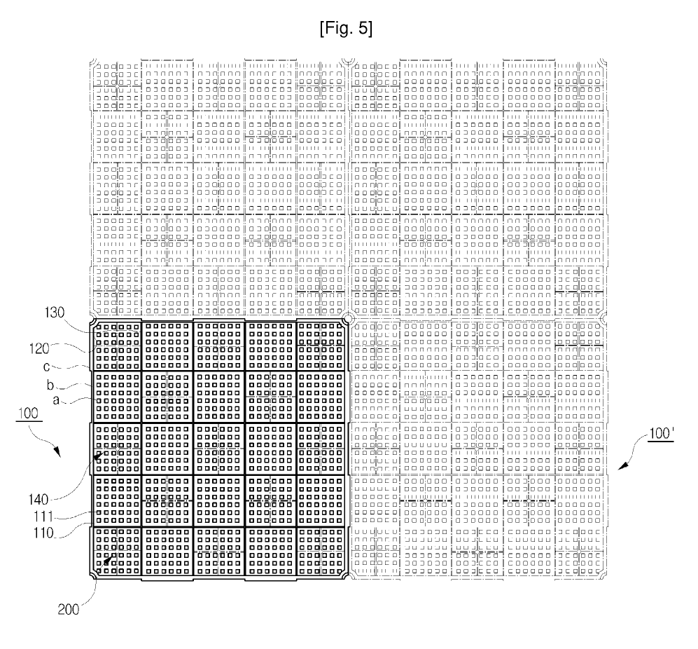

While such step blocks 400 can be inserted into all of the unit vegetation blocks 140 of the block frame 100, it is more preferable that the step blocks 400 be selectively inserted into the unit vegetation blocks 140, as shown in FIG. 5, so that plants or trees can grow.

When the bottom of the step block 400 contacts the top portion of the bottom plate 110, which has the holes a and is provided as the base of the block frame 100, the vegetation space is narrowed by the insertion of the step block 400. In order to prevent this problem, it is preferable that, as shown in FIG. 7, the spacer 200 is inserted into the lower portion of the unit vegetation space 140 and the step block 400 is seated on top of the spacer 200.

Preferably, the spacer 200 has a cross shape. Alternatively, the spacer 200 may have a different shape, such as a cylinder or a polygon.

In the block frame 100 or the vegetation block of this configuration, when the hook nut 310 is hooked to the net 300, which is placed on the ground or the bottom, as shown in FIG. 1, and the bolt 320 with the washer 321 fitted thereon is screwed into the hook nut 310, the block frame 100 can be prevented from coming loose from the bottom.

The procedures of constructing the vegetation block using the block frame 100, configured as above, are as follows.

First, the bottom or the ground, in which the vegetation block will be constructed, is planarized, and then the net 300 is placed on the planarized bottom or ground. Preferably, the net 300 is fixed to several points using anchor bolts (not shown) or the like.

Then, the hook nut 310 is hooked to the net 300, and the bottom portion of the corner of the block frame 100 is located above the hook nut 310. Here, the bottom portion of the bolt guide recess 125 is center-aligned with the nut hole of the hook nut, and the block frame 100′ is located in the same fashion, so that the bolt guide recesses can maintain the cylindrical shape.

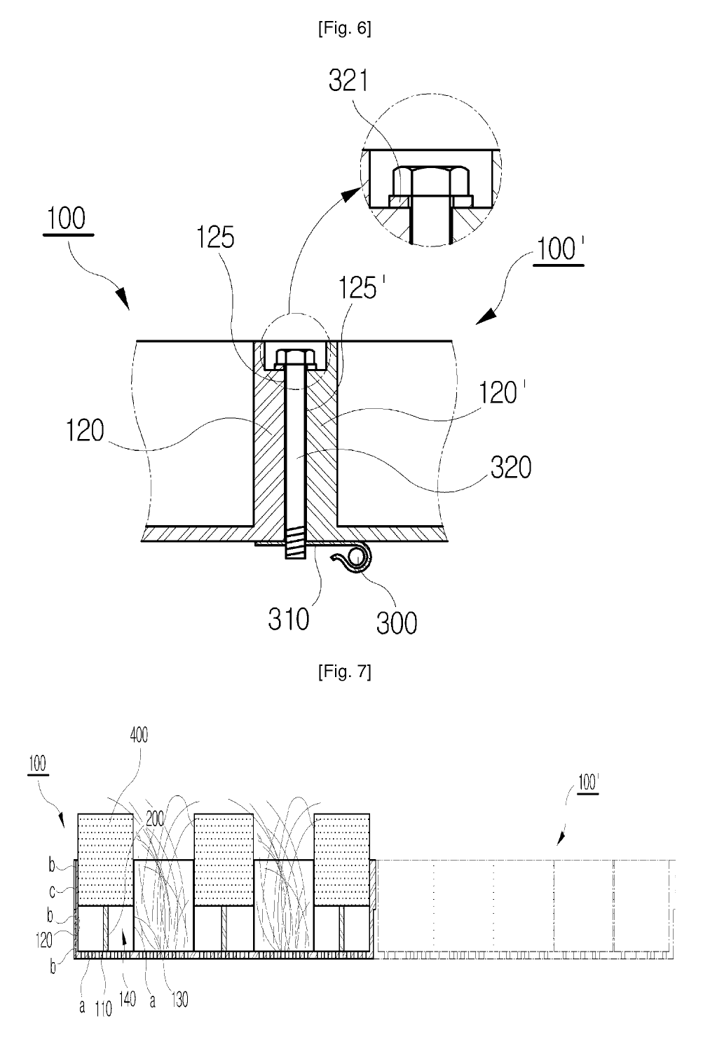

Next, as shown in FIG. 6, the bolt 320, with the washer 321 fitted thereon, is inserted and tightened into the bolt guide recess 125, which maintains a cylindrical shape, so that the block frame 100 closely contacts the ground or the bottom. By repeating these procedures, the step blocks 400 are selectively inserted into the unit vegetation spaces 140 of the block frame 100, as shown in FIG. 5. Then, the procedure of constructing the vegetation blocks is finished.

Here, the concavities b and the convexities c in the outer walls 120 of the block frame 100 are coupled with the concavities and the convexities of the block frame 100′, in order to prevent the block frame 100, after construction, from twisting in the longitudinal direction or being removed from the ground.

Furthermore, when the block frame 100 is delivered from the factory, soil mixed with nutrients, which are necessary for the rooting of plants, or other seeds can be placed inside the unit vegetation spaces 140. Then, after the block frames 100 and 100′ are constructed on site, seeds and soil can be poured into the unit vegetation spaces 140.

In order to enhance the rooting of plants, as shown in FIG. 7, the cross spacer 220 can be selectively inserted into the unit vegetation space 140 of the block frame 100, and then the step block 400 can be inserted into the unit vegetation space 140, so that the bottom of the step block 400 contacts the top portion of the inserted spacer 200.

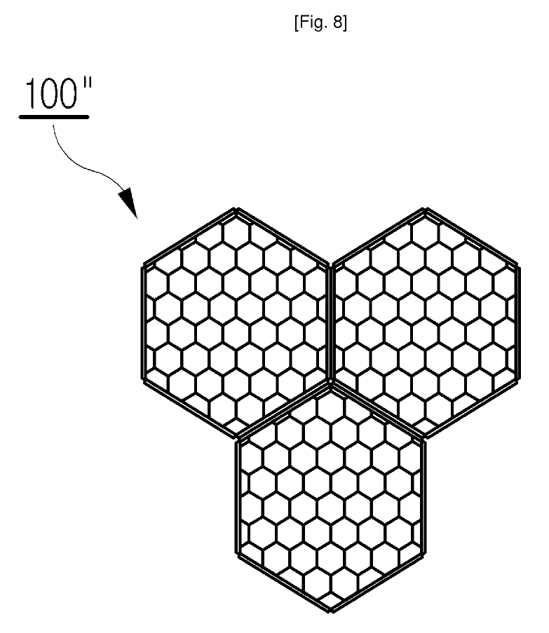

Although the invention has been described with respect to the square block frame 100 and the square unit vegetation space 140, which is provided inside the block frame 100, various shapes of block frames 100″ can also be used, as shown in FIGS. 8 to 18.

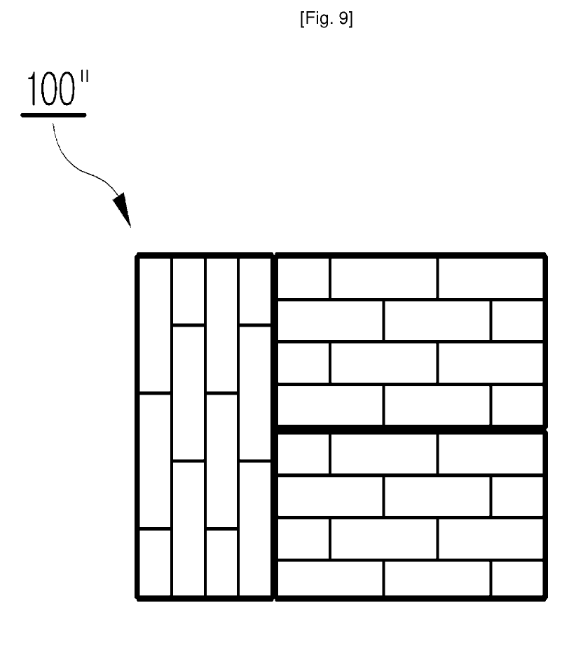

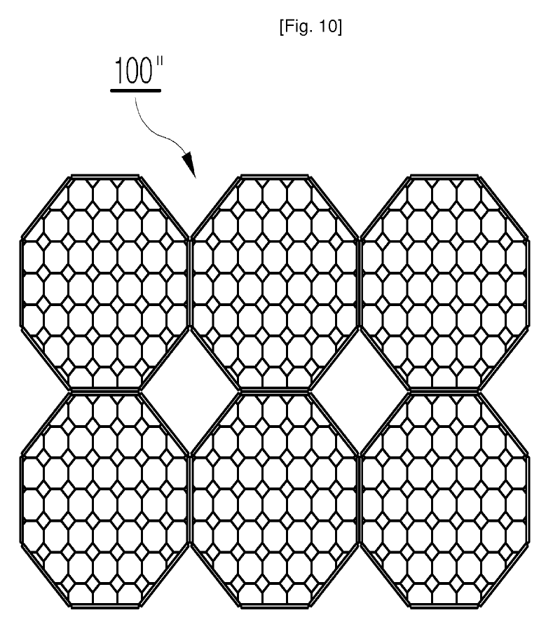

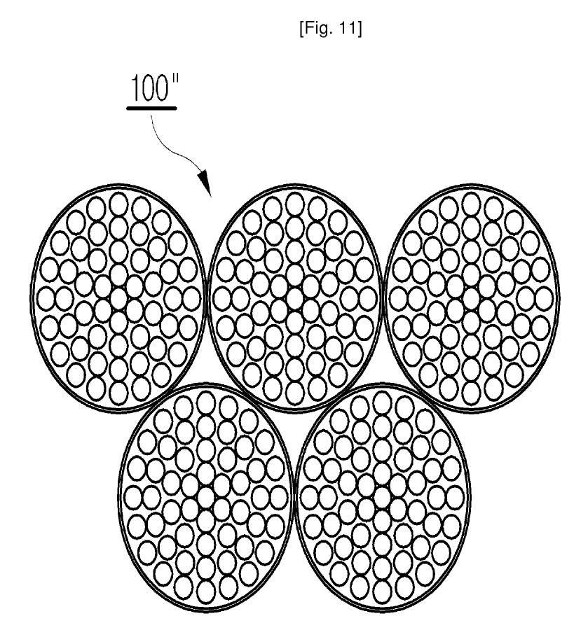

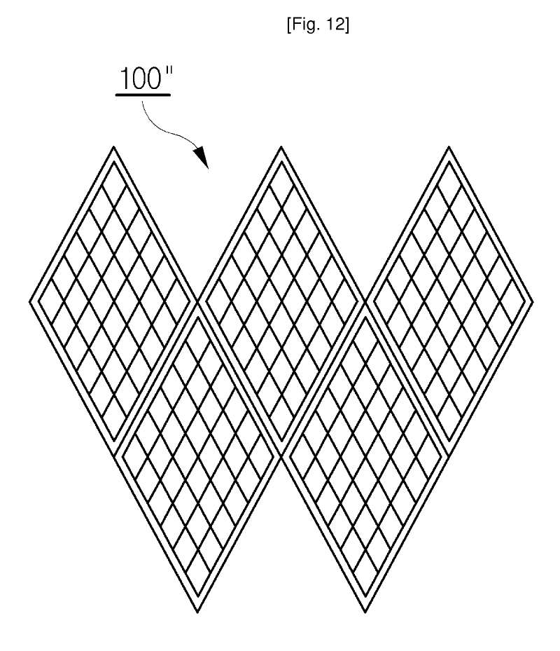

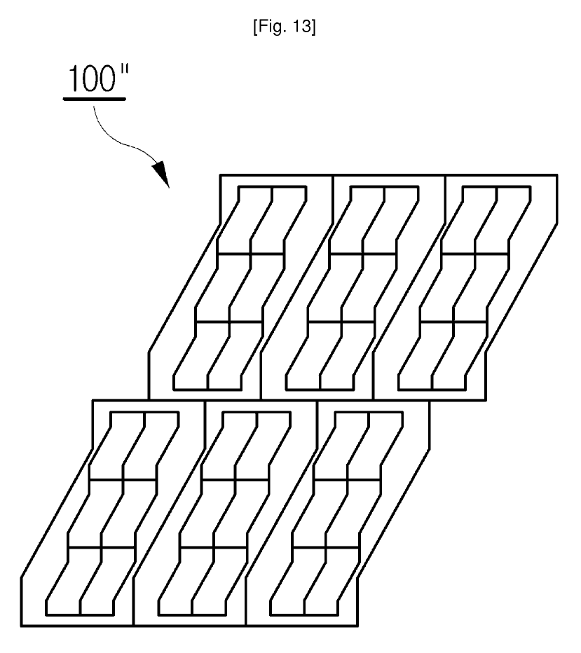

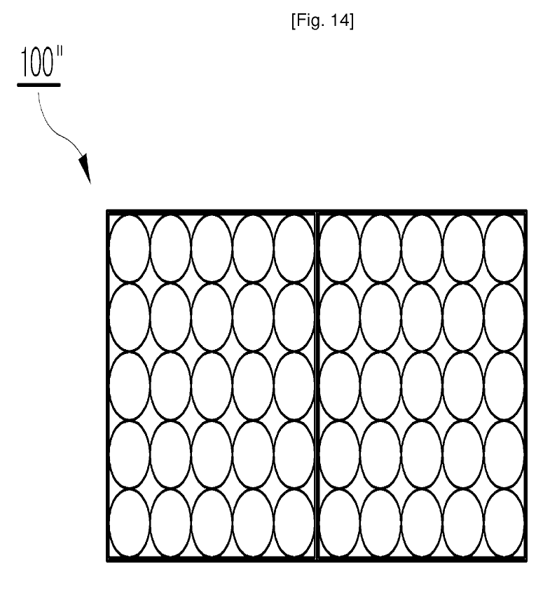

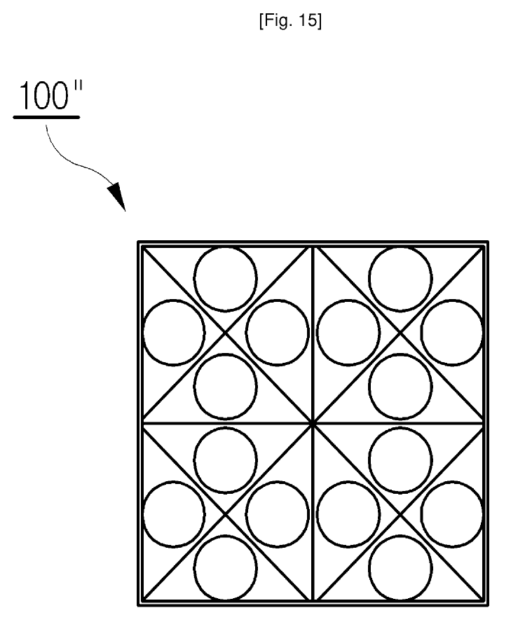

The block frames 100″ can be shaped as a honeycomb, as shown in FIG. 8, can be shaped as a floor board having rectangular panels, as shown in FIG. 9, and can be shaped as a hexagonal column and a cylinder, as shown in FIGS. 10 and 11. The block frames 100″ can be shaped as a diamond, as shown in FIG. 12, and can be shaped as a waved diamond, as shown in FIG. 13. As shown in FIG. 14, the block frames 100″ can include cylinders, which are repeatedly arranged inside a rectangular frame. Furthermore, as shown in FIG. 15, the inside of the rectangular frame can be diagonally divided.

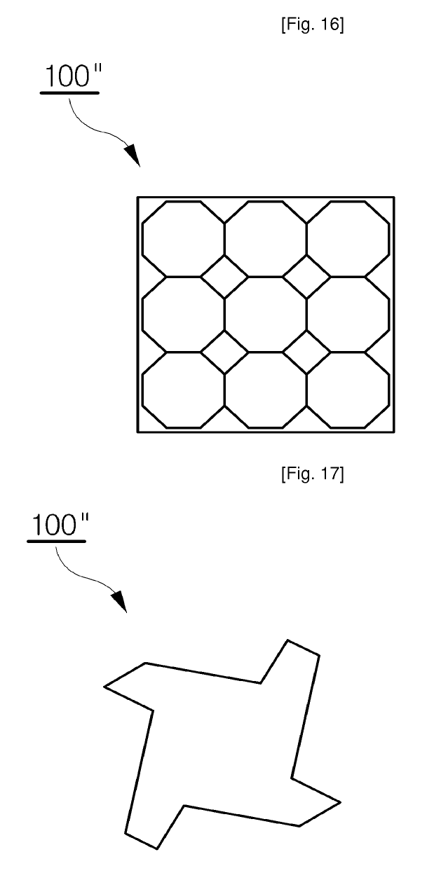

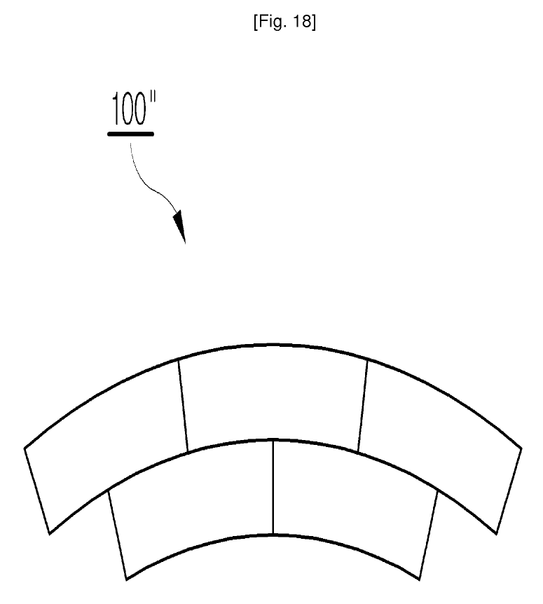

As shown in FIG. 16, octagonal unit vegetation spaces can be provided inside a rectangular frame. Furthermore, a weather vane shape, as shown in FIG. 17, can be used, and curved arcs having a predetermined length, as shown in FIG. 18, can also be used.

1. A vegetation block frame (100) of a multifunctional vegetation block, comprising:
a bottom plate (110);
outer walls (120), which define an inner space with the bottom plate (110); and
a plurality of partitions (130) extending crosswise and lengthwise inside the inner space, thereby forming a plurality of unit vegetation spaces (140),
wherein each of the bottom plate and the partitions has a plurality of holes (a), concavities (b) and convexities (c) are alternately formed in upper and lower parts of the outer walls (120), which are defined by a horizontal line at a vertical position corresponding to half a height (H) of the outer walls (120), and the concavities (b) and the convexities (c) also alternate with each other in a longitudinal direction of the outer walls (120).

2. The vegetation block frame according to claim 1, wherein the outer walls (120) of the block frame (100) have holes (a) formed therein,
wherein a stepped sector-shaped bolt guide recess (125) is vertically formed in an upper portion of a corner of the outer walls (120), and
wherein the bolt guide recess (125) contacts a bolt guide recess (125′), which is formed in a corner of outer walls of another vegetation block frame (100′),
thereby forming one cylindrical shape.

3. The vegetation block frame according to claim 1, further comprising a spacer (200) shaped as a cross, which is inserted into a corresponding one of the unit vegetation spaces (140).

4. The vegetation block frame according to any one of the preceding claims 1 to 3, further comprising:
a hook nut (310) for being hooked to a net (300), when the net (300) is placed under the vegetation block frame (100),
a bolt (320) having a washer (321) fitted thereon, wherein the bolt (320) is screwed into the hook nut (310), thereby tightly holding the hook nut (310) to a bottom.

5. A multifunctional vegetation block, comprising a step block (400) inserted into a vegetation block frame (100),
wherein the vegetation block frame (100) includes:
a bottom plate (110);
outer walls (120), which define an inner space with the bottom plate (110); and
a plurality of partitions (130) extending crosswise and lengthwise inside the inner space, thereby forming a plurality of unit vegetation spaces (140), wherein each of the bottom plate and the partitions has a plurality of holes (a), concavities (b) and convexities (c) are alternately formed in upper and lower parts of the outer walls (120), which are defined by a horizontal line at a vertical position corresponding to half a height (H) of the outer walls (120), and the concavities (b) and the convexities (c) also alternate with each other in a longitudinal direction of the outer walls (120); and
wherein the step block (400) is selectively inserted into a corresponding one of the unit vegetation spaces (140).

6. The multifunctional vegetation block according to claim 5, wherein the vegetation block frame (100) further includes a spacer (200) shaped as a cross, which is inserted into the corresponding unit vegetation space, and wherein the step block (400) is selectively inserted into the corresponding unit vegetation space, on top of the cross spacer (200).
